(19) United States
(12) Patent Application Publication
(10) Pub. No.: US 2026/0081946 A1
(43) Pub. Date: Mar. 19, 2026

(54) Dynamic Application Vulnerable Use Cases Identification in a Cloud Native Environment

(71) Applicant: Telefonaktiebolaget LM Ericsson (publ), Stockholm (SE)

(72) Inventors: Federico Pasini, Cogoleto- Genova (IT); Maurizio Pighetti, Genova (IT); Fabio Acquarone, Genova (IT)

(21) Appl. No.: 19/107,630

(22) PCT Filed: Sep. 2, 2022
(86) PCT No.: PCT/IB2022/058263

§ 371 Date: Feb. 28, 2025

(51) Int. Cl. H04L 9/40; H04L 43/045

(52) U.S. Cl. CPC H04L 63/1433; H04L 43/045; H04L 2463/146

(57) ABSTRACT

A management system (200) configures logging in telecommunication networks executing one or more services (230) in a distributed workflow. To accomplish its function, the management system obtains vulnerability information for one or more services currently deployed in a communications network. The vulnerability information comprises, for each of the one or more services a vulnerability identifier (VID) identifying a vulnerability of the service and a vulnerability score indicating a severity of the vulnerability. So obtained, the management system configures a logging framework (220) to generate trace records (406, 424) for a service currently deployed in the communications network to include the VID and the vulnerability score of the service. The management system configures the logging framework to generate the trace records on a use case basis. Therefore, each of the trace records are generated to identify a particular use case and use case instance associated with the execution of the service.

### TECHNICAL FIELD

The present disclosure relates generally to the management of telecommunication networks, and more particularly to tracing functionality for tracing and troubleshooting use cases executing in a distributed network flow.

### BACKGROUND

Software applications are used to control the processing associated with many different types of vertical and horizontal markets. For example, the processing associated with manufacturing operations, commercial operations, communications, health care, and mobility, are all controlled, at least in part, by software applications. Recently, the complexity of these types of software applications has increased, especially in environments where a plurality of software modules interact with each other over distributed platforms. Therefore, understanding the security vulnerabilities and the possible ways in which these applications can be exploited has become a key factor for monitoring, troubleshooting, and logging (e.g., tracing) purposes.

Industry and social trends are currently placing additional, more stringent requirements on tracing functionality. Further, such requirements are generally applicable across a wide array of technologies. For example, for virtualization technologies, tracing capabilities should be able to handle stacked layers and functions associated with cloud computing dynamic resource allocation. For 5G technologies, tracing capabilities should be able to handle issues related to latency, bandwidth monitoring, and mobile-to-mobile (M2M) scenarios. For autonomous technologies, such as autonomous driving, tracing capabilities should be configured to handle the processing associated with various types of vehicles, such as cars, ships, trains, and aircraft. Additionally, for e-commerce technologies, tracing capabilities should be able to handle workflows in Internet-Of-Things (IoT) networks, which typically comprise one or more Wireless Sensor Networks (WSNs).

Regardless of the particular technology, however, there is an increasing trend to pay more attention to security and privacy aspects. Consider, for example, the treatment of personal sensitive data. Often, such data is subject to a wide and heterogeneous set of regulations. Not only do such regulations evolve at a fast pace, but they can also differ from nation to nation. As another example, industrial and commercial information (e.g., the data related to configurations, volumes, and deployment of such applications) may/may not be subject to privacy regulations but are nevertheless extremely sensitive for the company that owns the information. Indeed, damages related to cyberattacks are well known, and therefore, security is at the top of the agenda for almost every company. Therefore, it is often vital that this information remain protected from others (e.g., competitors) unless the owner of the information decides to share the information.

The data produced by tracing mechanisms play a key role in understanding system behavior and how it can, or may, be affected by its vulnerabilities. Similar to how black boxes associated with avionics scenarios are essential to understand and create a course of action in case of air disasters, the capture and analysis of information associated with the vulnerabilities of a system, device, and/or application is basic ground for both development and production phases.

### SUMMARY

The present disclosure relates to tracing functionality in a distributed network environment. In particular, the embodiments described herein configure logging in a telecommunication network executing one or more services in a distributed workflow. In particular, embodiments of the present disclosure configure logging functions responsible for generating trace records for the services to identify one or more vulnerabilities that may affect the service, as well as the severity of the vulnerabilities. Additionally, the present embodiments configure the logging functions to include this information on a use case basis. Therefore, the logging functions are also configured to generate the trace records to identify the particular use case and use case instance affected by the vulnerabilities. Configuring logging functions to generate such information helps network operators to better understand the various vulnerabilities that are faced by the services currently deployed in the network, the extent to which those vulnerabilities affect those currently deployed services, and the possible corrective actions to take to mitigate those vulnerabilities and better protect the network.

Accordingly, in a first aspect, the present disclosure provides a method for configuring logging in telecommunication networks executing one or more services in a distributed workflow. In this aspect, the method is implemented by a network node in a management system and calls for obtaining vulnerability information for one or more services currently deployed in a communications network. The vulnerability information comprises, for each of the one or more services, a vulnerability identifier (VID) that identifies a vulnerability of the service and a vulnerability score indicating a severity of the vulnerability. Once the vulnerability information is obtained, the method calls for configuring a logging framework to generate trace records including the VID and the vulnerability score of a service currently deployed in the communications network for a use case associated with execution of the service.

A second aspect of the present disclosure provides a network node in a management system for configuring logging in telecommunication networks executing one or more services in a distributed workflow. In this aspect, the network node is configured to obtain vulnerability information for one or more services currently deployed in a communications network. The vulnerability information comprises, for each of the one or more services, a vulnerability identifier (VID) identifying a vulnerability of the service and a vulnerability score indicating a severity of the vulnerability. Additionally, the network node is configured to configure a logging framework to generate trace records including the VID and the vulnerability score of a service currently deployed in the communications network for a use case associated with execution of the service.

A third aspect of the present disclosure provides a network node in a management system for configuring logging in telecommunication networks executing one or more services in a distributed workflow. In this aspect, the network node comprises processing circuitry and memory circuitry. The memory circuitry comprises instructions that, when executed by the processing circuitry, causes the network node to obtain vulnerability information for one or more services currently deployed in a communications network. The vulnerability information comprises, for each of the one or more services, a vulnerability identifier (VID) identifying a vulnerability of the service and a vulnerability score indicating a severity of the vulnerability. Additionally, the instructions, when executed by the processing circuitry, causes the network node to configure a logging framework to generate trace records including the VID and the vulnerability score of a service currently deployed in the communications network for a use case associated with execution of the service.

A fourth aspect of the present disclosure provides a non-transitory computer readable medium. The medium comprises instructions stored thereon for managing telecommunication networks that, when executed by processing circuitry of a network node, configures the network node to obtain vulnerability information for one or more services currently deployed in a communications network. The vulnerability information comprises, for each of the one or more services a vulnerability identifier (VID) identifying a vulnerability of the service and a vulnerability score indicating a severity of the vulnerability. The instructions, when executed by the processing circuitry, further configure the network node to configure a logging framework to generate trace records including the VID and the vulnerability score of a service currently deployed in the communications network for a use case associated with execution of the service.

A fifth aspect of the present disclosure provides a computer program comprising executable instructions that, when executed by a processing circuitry in a network node, causes the network node to perform the method according to the first aspect.

A sixth aspect of the present disclosure provides a carrier containing a computer program according to the sixth aspect, wherein the carrier is one of an electronic signal, optical signal, radio signal, or computer readable storage medium.

### BRIEF DESCRIPTION OF THE DRAWINGS

FIG. 1 illustrates a distributed network system configured according to one aspect of the present disclosure.

FIG. 2 illustrates a management system configured to identify and log the vulnerabilities of network services according to one embodiment of the present disclosure.

FIGS. 3A-3B are diagrams illustrating the signal flows for configuring a logging framework to identify and log the vulnerabilities of network services according to one embodiment of the present disclosure.

FIG. 4 is a block diagram illustrating some example tracing information included in a log according to one embodiment of the present disclosure.

FIG. 5 is a flow diagram illustrating a method for configuring a logging framework to identify and log the vulnerabilities of network services according to one embodiment of the present disclosure.

FIG. 6A is a flow diagram illustrating a method for re-configuring the logging framework to identify and log newly discovered or changed vulnerabilities of network services according to one embodiment of the present disclosure.

FIG. 6B is a flow diagram illustrating a method for analyzing the vulnerabilities in the log traces and for generating a graphical user interface (GUI) that graphically indicates those vulnerabilities to a user according to one embodiment of the present disclosure.

FIG. 7 is a schematic diagram illustrating some exemplary components of a network node configured to implement aspects of the present disclosure.

FIG. 8 is a functional block diagram illustrating an example computer program that, when executed by the processing circuitry of a network node, configures the network node to implement aspects of the present disclosure according to one embodiment.

### DETAILED DESCRIPTION

As stated above, current industry and social trends place additional, more stringent requirements on tracing functionality across a wide array of technologies. Additionally, it is becoming increasingly important to pay more attention to security and privacy aspects of network systems and the services executing in these systems. Accordingly, the present disclosure provides a system and method for capturing and analyzing information associated with the vulnerabilities of the network system and/or the services running on these systems. To accomplish this function, embodiments of the present disclosure dynamically configure a logging framework that is responsible for generating trace records for a given service on a use case basis to additionally include information identifying the specific vulnerabilities of the given service.

In more detail, many computer programming paradigms utilize third-party software components when creating services for deployment on communications networks. As is known in the art, a third-party software component is a reusable software component developed to be either freely distributed or sold by an entity other than the original vendor of a development platform. In most cases, application developers tend to use third-party libraries to accelerate the development of a service or other software application. However, use cases and their associated vulnerabilities are generally present throughout the entire lifetime of the service, and knowledge of such information is advantageous across each life-cycle stage. For example, during the development phase of a service, knowledge of the vulnerabilities of a given service can help identify appropriate customer needs and requirements for application features. During the testing phases for a service, such information can be used to uncover, identify, and solve various malfunctions related to the service, and to validate application features. When a service is running in a live network, knowledge of this information can reveal if and how such vulnerabilities can potentially impact, or are impacting, a user's work and/or experience with the given service.

Currently, there are various databases available that store known vulnerability information. One such source is a Common Vulnerabilities and Exposures (CVE) database provided by the National Institute of Standards and Technology (NIST), although other such databases and information may exist and be provided by other entities. As defined herein, and by NIST, a “vulnerability” is a weakness in the computational logic (e.g., code) found in software and hardware components that, when exploited, results in a negative impact to confidentiality, integrity, or availability. Mitigation of a vulnerability in this context typically involves coding changes but could also include specification changes or even specification deprecations (e.g., removal of affected protocols or functionality in their entirety).

The CVE is a list of entries. Each CVE entry contains an identification number (i.e., a CVE identifier that identifies a particular vulnerability), a description of the vulnerability, and at least one public reference. CVE entries are used globally in numerous cybersecurity products and services, including the U.S. National Vulnerability Database. Whenever a vulnerability (i.e., a CVE) is found and identified, software companies release a patch. Users can then download the patch and repair the vulnerability. Many companies have a patch-management solution to address patching systems in their network; however, even after a patch is released, companies still lack important information. For example, companies typically are not able to accurately validate whether a given patch works when in a production system. They also lack adequate knowledge regarding whether a given patch was properly applied and completed. Dynamically configuring logging frameworks according to the present disclosure, however, can help mitigate these issues.

Additionally, as previously described, logging is a concept that most developers use for debugging and diagnostic purposes. However, security logging is an equally basic and important concept. Specifically, security logging is the logging of security information during runtime operations of an application (e.g., a service deployed in the network). Monitoring is the live review of the application (e.g., service) and the security log traces associated with those applications using various forms of automation. In some cases, the same tools and patterns can be used by companies for operational purposes, debugging purposes, and security purposes.

However, conventional solutions for capturing vulnerability information are problematic. For example, there are currently no standardized procedures for logging. Although there are some proposals for standardized logging (e.g., Opentracing—see https://opentracing.io/), they do not address tracing the vulnerabilities of a service or application at a use case level. Additionally, current CVEs do not identify all of the vulnerabilities found in third-party software packages. In many cases, other unidentified weaknesses exist in these packages and are found only after a packaged is delivered and installed. Even if most of the critical vulnerabilities in a given third-party library are disclosed as CVEs, other applications, such as other third-party libraries and/or services, are not updated in a timely manner.

The developers of a given application (e.g., service) typically perform their own vulnerability assessment for their software packages. However, this merely provides an “aseptic” understanding of how a vulnerability affects a system (or service). That is, conventional methods for collecting and analyzing the vulnerabilities associated with a given third-party package allow developers (and/or other users) to view the vulnerability related issues only as single aspect of a problem that is often times large and more complex. This is because conventional methods are not configured to collect a wide set of trace logs from different processes and correlate them together on a use case basis to accurately assess the real vulnerabilities of the use case.

In some cases, scans are performed on an application in an attempt to expose and/or identify a potential vulnerability. However, interpreting the results of such scans requires various levels of expertise available only from different teams based in different countries and potentially diverse companies. Further, such conventional application vulnerability scans are not performed dynamically, but rather, are performed statically. Thus, conventional methods do not provide an understanding of how a given vulnerability directly affects a use case of an application.

These issues, and others, are exaggerated when considering the complexity and nature of today's networks and services. For example, from a technical point of view, the implementation or execution of a given service in distributed system often requires the interaction of several different services or functions (e.g., different applications, microservices, etc.)-each of which has its own vulnerability or set of vulnerabilities. However, identifying and analyzing these vulnerabilities in a runtime environment are extremely complex. This is because a given feature in a distributed system often comprises many different services or interact with many different services. Additionally, many users (e.g., hundreds or more) can utilize the same feature of a service. Given these aspects, especially when applied to thousands of use cases, conventional logging methods are unable to provide anything more than an overall view of the operation of a given system. To obtain knowledge of a particular vulnerability, conventional systems require a user to search through the logfiles of each independent service to look for the logfile that contains desired information. If a file is identified, the user is then required to “cherry-pick” the needed information from all the “noise” (i.e., unrelated information) contained in the identified logfile. Assuming the user can glean the needed information, the user can alter service logic accordingly. However, if the result is not what the user expected (e.g., the changes do not mitigate the vulnerability), the entire process is repeated with different actions or functions in the call flow of the service.

Therefore, conventional methods of identifying analyzing the vulnerabilities of a given service are inadequate. Vulnerability scans, in some cases, are part of a service's Continuous Integration/Continuous Delivery (or Deployment) (CI/CD) activity. However, once the service is released into an execution environment, such as in a distributed network, security infrastructure administrators have no tracing mechanisms available to them with which to monitor the security threats of the services that are subject to vulnerabilities. Moreover, conventional systems do not enable system operators to verify whether there are any services actually executing in the system that are affected by a particular vulnerability. Such a lack of knowledge prevents system administrators from implementing any strategy that rearranges the manner in which operative procedures are acted upon in order to minimize potential security-related threats.

Accordingly, embodiments of the present disclosure provide a system and method classifying the vulnerabilities of the services deployed in a distributed communications network and for configuring a logging framework to generate trace logs for a service that identify the classified vulnerabilities on a use case basis. Such information helps to speed the analysis of a given logfile and is useful during all lifecycle stages of a service (e.g., from the early development stage of a service to the delivery/deployment, execution, and customer support phase of a service).

In more detail, the present embodiments provide a method and apparatus configured to identify the vulnerabilities (e.g., those associated with third-party service applications) that potentially impact a given network service, and export that information in the application logs for the use cases that may be potentially impacted the identified vulnerabilities. To accomplish its functions, the present disclosure identifies the currently known vulnerabilities for a service and then configures a logging framework to generate trace logs including known vulnerabilities for each use case and use case instance.

In one embodiment, for example, the present disclosure provides a management system configured to tag the logs generated for a use case with information identifying the known vulnerabilities of various third-party software packages. More specifically, the management system is configured to obtain “vulnerability information” identifying the vulnerabilities of one or more services, as well as information identifying the particular services that are currently deployed in the network. According to the present disclosure, the vulnerability information and the identifying the deployed services are dynamically obtained and updated in real-time (i.e., responsive to the information changing). The management system then configures a logging framework to associate the obtained vulnerability information on a use case basis with the trace logs that are generated by the logging framework for the one or more services. So generated, the management system provides a graphical user interface (GUI) that graphically indicates the generated log traces and their effects on the services and/or the network along with one or more tools to filter the logfile information.

Embodiments of the present disclosure provide benefits and advantages to logging systems that conventional methods and devices cannot or do not provide. For example, a management system configured according to the present disclosure provides security infrastructure administrators, and other entities, with a real-time view of the particular vulnerabilities that may be affecting the services running in the network. It also provides a real-time view into how those services, and the workloads associated with those services, are affected by the vulnerabilities. Armed with this knowledge, a security infrastructure administrator can, for example, apply one or more risk mitigation actions (e.g., remove an active service from the network, block or restrict access to a service, etc.). For instance, given a particular service deployed and active in the network, an administrator may implement a risk mitigation action for the service responsive to the management system identifying a new high-risk vulnerability that was introduced into a vulnerability database (e.g., the CVEs in a NIST database) that can affect the service.

Further, as stated above, the vulnerability information identifies a severity for the vulnerability. In these cases, the risk mitigation actions performed on the service may be applied based on this severity or based on whether the severity of the vulnerability has changed (e.g., increased) from its previously known severity.

Additionally, the functionality provided by a management system configured according to the present embodiments allows network administrators and network operators to monitor and/or verify the use cases that are affected by a given vulnerability as those use cases execute in a production environment in real-time (e.g., as active services execute in the network). Such knowledge allows, for example, the administrators/operators to re-arrange operational procedures for a service such that the use cases affected by the vulnerability occurs as infrequently as possible until a software upgrade solving the vulnerability is available for deployment. Additionally, the information provided by the management system, by way of actively configuring a logging framework according to the present disclosure, allows software providers to understand their impact on the customers, and therefore, prioritize fixing the vulnerabilities accordingly.

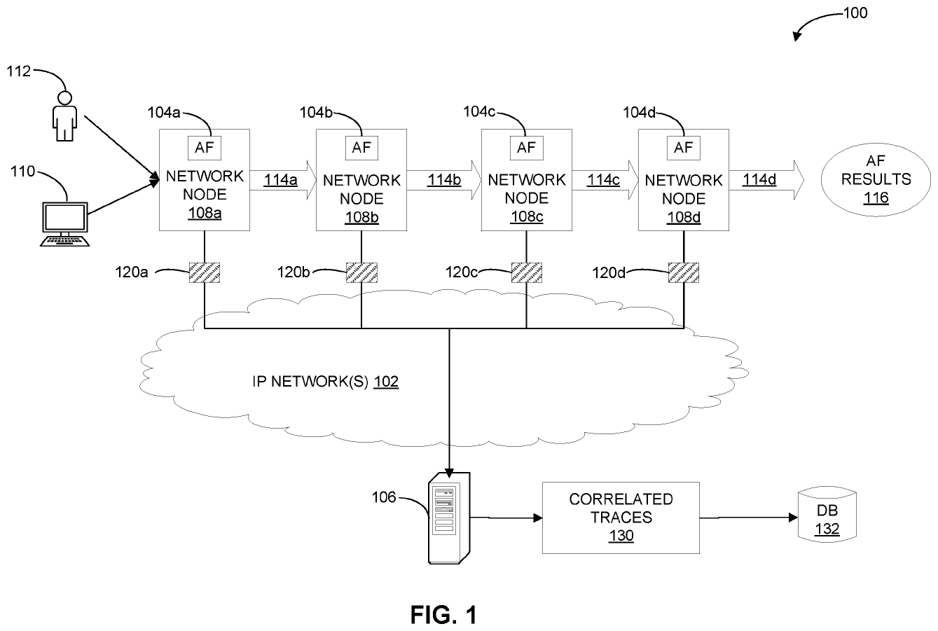

Referring now to the drawings, and particularly to FIG. 1, an exemplary distributed network 100 is shown. The distributed network 100 comprises one or more IP networks 102 communicatively interconnecting a plurality of network nodes 108a-108d to a correlation server 106. Each of the network nodes 108a-108d comprises a respective atomic function (AF) 104a-104d that processes data according to its particular instructions. Each AF 104a-104d also provides a corresponding output 114a-114c that is received as input by a corresponding downstream AF 104b-104d.

As described herein, the network nodes 108a-108d may be in the same communications network or they may be distributed throughout one or more different communications networks. Similarly, AFs 104a-104d may be disposed on and executed by the processing circuitry of a single network node 108, or on different network nodes 108 and distributed throughout one or more different communications networks. Regardless, the present embodiments configure network nodes 108a-108d to generate trace records at particular trace points. Each generated trace record is associated with a particular “use case” and is correlated with other trace records generated for the use case.

A “use case,” as defined herein, is a scenario in which a system such as distributed network 100 receives an external request and responds to it. For example, a use case may be a user checking the configuration of a node or software application. Another example of a use case is a node raising an alarm. Still other examples of uses cases include, but are not limited to, a user registration process for a streaming platform, storing the high score of a videogame to memory, establishing a communication link for a video conferencing application, and communicating video data during an established video conferencing session.

Regardless of the particular use case, though, an “initiator” starts the use case. As seen in FIG. 1, for example, an “initiator” may be a user input terminal 110, a user 112, or the like. The initiator begins a use case by providing input data, for example, to network node 108a. The AF 104a in network node 108a then processes the input data according to its programming and sends any resultant output data 114a to the next downstream network node 108b for input into AF 104b. Upon receipt, AF 104b performs its processing and provides its output data 114b to network node 108c. This process continues with the AF 104 in each network node 108 processing the input data it receives and providing corresponding output data 114a-114d to the next network node 108 for processing by the next AF 104. When the AFs 104 have finished processing, the output is provided in the AF Result 116.

In the context of the present disclosure, an “atomic function” 104 is the smallest possible piece of code (e.g., a code module, function, etc.) that when executed by the processing circuitry of a corresponding network node 108, performs some specific task in support of a use case. That is, each AF 104a-104d comprises a set of uninterruptible instructions executable by the network node. For example, consider a use case example in which a user's high score is to be saved to a database. In such a use case, AF 104a-104d may comprise the code required to, respectively, open a database, read a database record (e.g., a high score record) from the database, write data (e.g., a new high score) to the database record, and update the database with the updated database record. In each case, the processing circuitry of a network node 108 executes the programming of its corresponding AF 104 from beginning to end without interruption. Regardless of its particular task or functionality, however, each AF 104 comprises a set of uninterruptible instructions executable by the network node.

In addition to the programming for its intended function, each AF 104a-104d is specifically configured to generate one or more trace records 120a-120d at particular trace points during the distributed call flow. Each trace record, which will be described in more detail later, is sent by a corresponding one of the AFs 104 to correlation server 106 via IP network(s) 102. Upon receipt, correlation server 106 correlates the individual trace records 120a-120d into a unified trace record 130 for storage in a database 132. Thereafter, a user such as a systems analyst, for example, can retrieve and analyze the correlated trace records 130 from DB 132 to troubleshoot a use case, for example.

The network nodes 108a-108d seen in FIG. 1 play different roles with respect to use case processing at runtime in distributed network 100. For example, network node 108a fulfills an “initiator role.” In the initiator role, AF 104a of network node 108a processes the received input data and generates a use case indicator for the use case. As described in more detail later, the use case indicator is unique to a use case and identifies the use case and the particular instance of the use case. At the other end of the distributed workflow, network node 108d fulfills a “terminator role.” In the terminator role, AF 104d receives the output provided by upstream AF 104c, processes it, and generates output 114d for AF results 116. The remaining network nodes 108b-108c fulfill “continuer roles.” In this role, each AF 104b, 104c processes incoming data and generates appropriate output to send as input to the next downstream AF 104.

Regardless of their particular role, however, network nodes 108b-108d do not alter the unique use case indicator once it has been generated. Thus, the generated use case indicator remains unchanged by the processing of any of the in downstream AFs 104b-104d. This is because the use case indicator, according to the present embodiments, is sent to correlation server 106 in the trace records 120 where it is used to generate the correlated trace record 130. Thus, the use case indicator uniquely identifies a complete trace for any given use case.

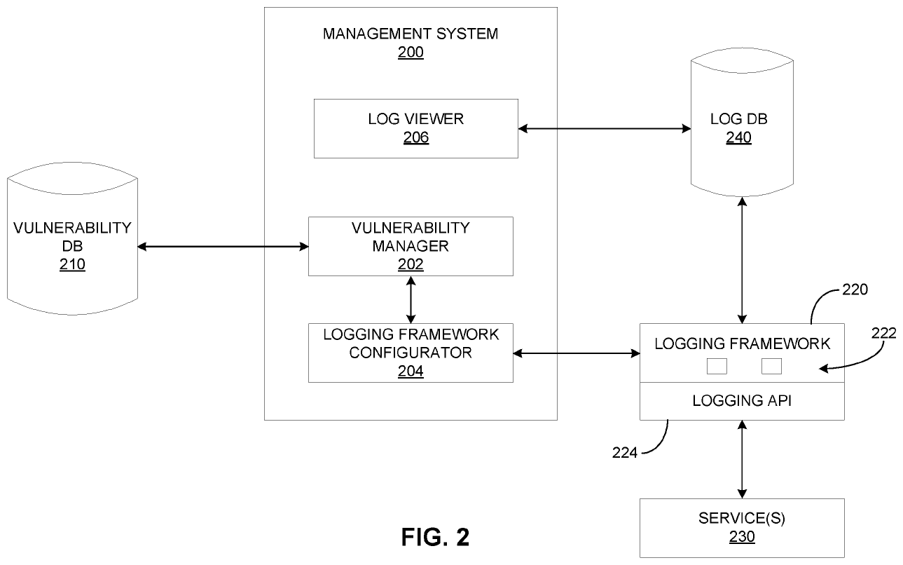

FIG. 2 illustrates a management system 200 configured to identify and log the vulnerabilities of one or more services 230 deployed in a communications network according to one embodiment of the present disclosure. As seen in FIG. 2, management system 200 comprises a vulnerability manager 202, a logging framework configurator 204, and a log viewer 206. In general, management system 200 provides a new service that identifies the vulnerabilities of a service with use case granularity. In this embodiment, the vulnerability manager 202 communicatively interfaces with a NIST vulnerability database (DB) 210 and the logging framework configurator 204 communicatively interfaces with a logging framework 220.

In this embodiment, the vulnerability manager 202 obtains vulnerability information from the vulnerability DB 210. Such information may be obtained by vulnerability manager 202 upon initialization of the vulnerability manager 202, or in real-time whenever such information has been updated or changed. For example, whenever a new vulnerability has been added to the vulnerability DB 210, or whenever the severity of a vulnerability has changed, vulnerability manager 202 can initiate operations to retrieve the updated information. Additionally or alternatively, vulnerability manager 202 can subscribe to receive the updated vulnerability information such that the vulnerability information is “pushed” to the vulnerability manager 202 whenever a component of that vulnerability information has changed. In this embodiment, the vulnerability information includes, but is not limited to, a Vulnerability Identifier (VID) that identifies a particular vulnerability of a given service deployed in the network and a vulnerability score (e.g., HIGH, MEDIUM, LOW) of the vulnerability identified by the VID.

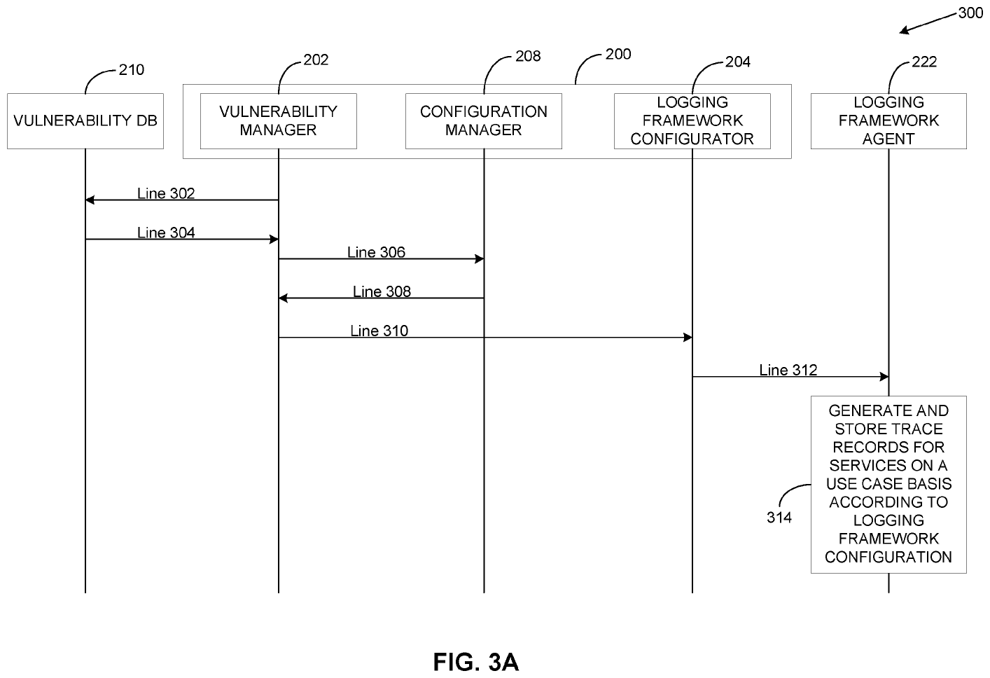

Additionally, as described in more detail with respect to FIGS. 3A-3B, vulnerability manager 202 also communicatively interfaces with a Configuration Manager (CM) associated with the network. This connection allows the vulnerability manager 202 to obtain service configuration information regarding the configuration of the various services and service instances currently deployed in the network. In this embodiment, the service configuration information includes, but is not limited to, a Service Component Identifier (SCID) that identifies a particular service and/or service instance. Such service configuration information may, as described above, be actively obtained by vulnerability manager 202 (e.g., using a request-response messaging protocol, for example) and/or passively obtained by vulnerability manager 202 as the result of one or more subscriptions to receive the updated information. The vulnerability manager 202 may also be configured to check the vulnerability DB 210 to check for any new vulnerabilities that are associated with the service, and/or to determine whether any related vulnerabilities for the service exist or have changed.

Regardless of the particular method for obtaining the data, the service configuration information obtained from the vulnerability DB 210 may identify a given service, whether the given service is a third-party service, and/or whether the given service was developed using any of a variety of known third-party packages. So obtained, vulnerability manager 202 provides the logging configurator 204 with the information it needs to configure the logging framework 220 according to the present embodiments. Such information includes, for example, the VID identifying a particular vulnerability of the service identified by the SCID, and a vulnerability score (e.g., HIGH, MEDIUM, LOW) of the vulnerability identified by the VID.

The logging framework configurator 204, as stated above, is aware of, and establishes a communications link with, logging framework 220. In this context, the logging framework configurator 204 is agnostic as it is configured to communicatively interface with many different logging frameworks 220 regardless of protocol. Thus, the logging framework configurator 204 effectively functions as a “mediation” layer between the management system 200 and one or more different logging framework implementations. Additionally, the logging framework configurator 204 receives the SCID, VID, and the corresponding vulnerability score from the vulnerability manager 202 and configures the logging framework 220 with that data. In one embodiment, for example, the logging framework configurator 204 generates a logging framework configuration file comprising this information provided by the vulnerability manager 202 and sends that file to the logging framework 220 via the established connection. According to the present embodiments, this controls the logging framework 220 to generate trace records 120 for a given use case of a service to include the SID, VID, and the vulnerability score in addition to other information, as described more fully below. The information may, for example, be provided in dedicated and/or additional fields of the trace records 120.

The logging framework 220 in this embodiment is a core service available in a cluster and comprises one or more logging agents 222. In general, logging framework 220 configured according to the present disclosure provides log transformation features in a highly configurable manner. An example of such a logging framework 220 includes, but is not limited to, the ELASTICSEARCH suite, which allows for the configuration of the logging agents 222 (e.g., FILEBEAT or FLUENTBIT) in order to transform the log data. According to the present disclosure, the logging agents 222 are configured to generate the trace records 120 in accordance with the configuration file(s) provided by the logging framework configurator 204.

Services 230 generate their respective log files by calling the functions of a particular Logging Application Programming Interface (API) 224. Upon receipt of the data from service 230, the logging agents 222 of logging framework 220 generate or transform the data into appropriate trace records 120. To accomplish this, the logging agents 222 perform their functions according to the configuration provided by logging framework configurator 204. Particularly, the logging agents first determine whether the data they receive is from a service 230 (or other third-party package) that has a known vulnerability. To determine this, the logging agents 222 may compare the SCID of the service 230 sending the data to those on the CVE list sent by the logging framework configurator 204. Provided the SCID is on the CVE list, the logging agents 222 will generate the trace record 120 to include the corresponding SCID, the VID, and the vulnerability score, as well as the UCID identifying the particular use case and use case instance. If the SCID is not on the list, however, the logging agent 222 will generate the log record to simply include the UCID. Regardless of whether the trace records 120 are generated to include the vulnerability information, however, the generated trace records 120 are sent to the log database 240 for storage. As will be described in more detail later, the data included in the generated trace records 120 may be retrieved by log viewer 206 and viewed in a GUI that is generated and displayed to a user.

FIGS. 3A-3B are diagrams illustrating the signal flows for configuring a logging framework 220 to identify and log the vulnerabilities of network services 230 according to one embodiment of the present disclosure. It is assumed that during a development phase of a service 230, the use cases performed by the service 230 are identified and assigned unique UCIDs. Additionally, for each of these use cases, a set of micro-services involved in the processing of data by the service 230, if any, are also identified. The micro-services may be, for example, APIs or other functions called by the service 230, or other functions included in the service 230. If any of these micro-services (or other processes) are themselves associated with a “related” use case, than the UCID of that “related” use case is also identified. In at least one embodiment, the hardware on which the service 230 and/or the micro-services execute is also identified.

The example signaling procedure 300 of FIG. 3A occurs upon initialization of management system 200 and/or whenever the data in the vulnerability DB 210 is updated or otherwise refreshed. In particular, the vulnerability manager 202 first sends a request message, which may be an explicit message or a subscription request, to the vulnerability DB 210 requesting that it provide the CVE list (line 302). In response, the vulnerability DB 210 provides the CVE list to the vulnerability manager 202 (line 304). As stated previously, each entry on the CVE list may comprise a VID uniquely identifying a known vulnerability and a corresponding vulnerability score for the known vulnerability. However, other information, such as a description of the known vulnerability, the date the known vulnerability was identified, and/or other data related to the known vulnerability may also be provided.

The vulnerability manager 202 also sends a request message to the configuration manager entity (CM) 208 requesting that it identify the services 230 that are currently deployed in the network (line 306). As above, the request message sent to CM 208 may be an explicit request message or it may be a subscription request message. Regardless, CM 208 provides the vulnerability manager 202 with a list of services 230 that are currently deployed in the network (line 308). The list may comprise, for example, a list of SCIDs identifying the currently deployed services 230.

Once vulnerability manager 202 has obtained the information from the vulnerability DB 210 and the CM 208, it sends the information in a message to the logging framework configurator 204 (line 310). The logging framework configurator 204 then generates one or more logging configuration files based on the data received from the vulnerability manager 202 and sends them to the logging framework 220 (line 312) thereby configuring the logging framework agents 222 to generate trace records 120 on a use case basis and store the generated trace records 120 in the log DB 240 (box 314).

Once the logging framework 220 has been initially configured or updated in response to receiving new or updated vulnerability information (seen in FIG. 3A), it may occur that a new service 230 is deployed in the network or that the logic of an existing service 230 is updated. The example signaling 320 of FIG. 3B illustrates how management system 200 handles such situations according to one embodiment of the present disclosure.

As seen in FIG. 3B, the vulnerability manager 202 receives information from CM 208 identifying any new services 230 that have been deployed in the network, or any services 230 that have had their logic updated (line 322). This information may be provided, for example, as a list of one or more SCIDs (along with other information as needed or desired), and in response to an explicit request made by vulnerability manager 202 and/or a previous subscription request made by vulnerability manager 202. Once the list of SCIDs has been received from CM 208, the vulnerability manager 202 generates and sends a request for, and subsequently receives, the vulnerability information for those SCIDs from the vulnerability DB 210 (lines 324, 326). Then, as above, the vulnerability manager 202 provides the vulnerability information for the SCIDs identified by CM 208 to the logging framework configurator 204 (line 328).

Upon receipt of the vulnerability information from the vulnerability manager 202, logging framework configurator 204 generates one or more logging configuration files based on the data received from the vulnerability manager 202 and sends those files to the logging framework 220 (line 330). As previously described, these configuration files configure the logging framework agents 222 to generate trace records 120 on a use case basis and then store the generated trace records 120 in log DB 240 (box 332).

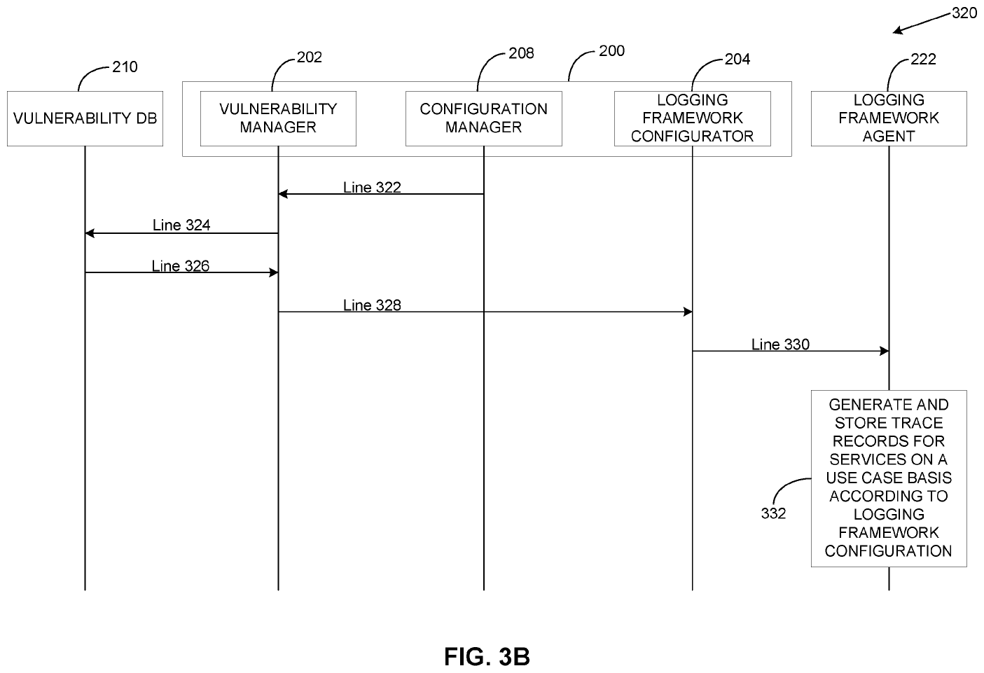

FIG. 4 illustrates some example tracing records 400 that are generated by a logging framework 220 according to one embodiment of the present disclosure. As seen in FIG. 4, there are three services-Service A 402, Service B 410, and Service C 420. Each service 402, 410, and 420 is configured to call the logging functions provided by the logging API 224 of logging framework 220 to generate respective trace records 404, 412, and 422. Further, each trace record 404, 412, and 422 comprises information that will be stored in the log DB 240 for subsequent analysis and output to a GUI for viewing by a user. Although the trace records 404, 412, and 422 may contain any type of information needed or desired, one embodiment of the present disclosure configures the logging framework 220, and more specifically, the logging agents 222, to generate trace records 404, 412, and 422 to comprise a log body (e.g., text describing the trace and/or an alphanumeric code identifying the trace), the UCID uniquely identifying the particular use case associated with the trace, and a use case instance identifier that identifies the instance of the use case identified by the UCID.

It should be noted here that this embodiment illustrates the UCID and the use case instance identifier INSTANCE as two separate pieces of information. However, those of ordinary skill in the art will readily appreciate that this is for illustrative purposes only, and that the present embodiments are not so limited. In other embodiments, for example, the UCID and the use case instance identifier INSTANCE comprise a single value (e.g., a concatenated value). Regardless of whether these identifiers are contained in a single value or separate values, however, both function to uniquely identify a particular use case and use case instance being executed by a respective service 402, 410, or 420.

As previously described, the logging framework 220 is configured according to embodiments of the present disclosure to generate trace records to further include the vulnerability information obtained from the vulnerability DB 210. Thus, trace records 406, 414, and 424 are generated, respectively, for services 402, 410, and 420. As seen in FIG. 4, trace records trace records 406, 414, and 424 include both the UCID and INSTANCE values to identify the use case and use case instance for the service. However, only trace records 406 and 424 additionally comprise value VID and SEVERITY (i.e., the vulnerability information). This is because of the three services in FIG. 4, only Service A 402 and Service C 420 have vulnerabilities identified in the vulnerability DB 210. Further, as seen in trace record 424, a given service (e.g., Service C 420) may be subject to multiple associated vulnerabilities. In these cases, the logging framework configurator 204 configures the logging framework 220 to generate trace record 424 to include the VID and SEVERITY values for each vulnerability.

In contrast to Services A and C 402 and 420, this embodiment of Service B 410 does not have any vulnerabilities associated with it. Therefore, as seen in FIG. 4, any corresponding trace records generated for Service B 410 include values only for the UCID and INSTANCE. As previously described, however, should any vulnerabilities be subsequently associated with Service B (e.g., see the embodiments of FIGS. 3A-3B), the logging framework 220 would be reconfigured to include the corresponding VIDs and SEVERITY values when generating trace record 424.

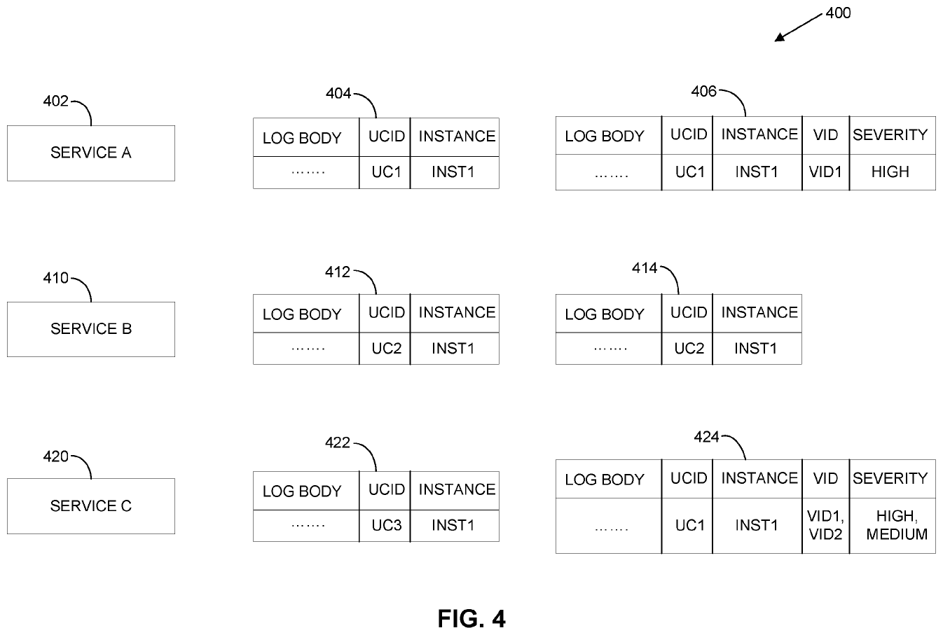

FIG. 5 is a flow diagram illustrating a method 500 for configuring a logging framework 220 to identify and log the vulnerabilities of network services 230 according to one embodiment of the present disclosure. In this embodiment, method 500 is implemented at a single network node; however, those of ordinary skill in the art should readily appreciate that method 500 may be implemented by a plurality of different network nodes distributed throughout the network.

As seen in FIG. 5, method 500 begins with the network node obtaining vulnerability information for one or more services 230 currently deployed in the communications network (box 502). As previously described, the vulnerability information comprises, for each of the one or more services, a vulnerability identifier (VID) that identifies a vulnerability of the service 230, and a vulnerability score that indicates the severity of the vulnerability. Additionally, as seen in method 500, the network node obtains a list of one or more service component identifiers (i.e., the SCIDs) from CM 208 (box 504). Each SCID identifies a respective service 230 currently deployed in the network and a version of that service 230. Once this information has been obtained, the network node configures the logging framework 220 with the list of one or more SCIDs (box 506), and also configures the logging framework 220 to generate trace records to include the VID and the vulnerability score of the currently deployed service (box 508). As previously described, the logging framework 220 is configured to include this vulnerability information in the trace records on a use case basis.

In at least one embodiment, the logging framework 220 is configured by the logging framework configurator 204 to generate at least one trace record (e.g., trace record 424) to include a plurality of VIDs and a plurality of corresponding vulnerability scores. In these cases, each VID in the generated trace record identifies a different vulnerability of the service.

Additionally, in one aspect, the logging framework 220 is configured by the logging framework configurator 204 to generate the trace records when an SCID of the service 230 associated with the use case matches an SCID on the list of one or more SCIDs provided by the logging framework configurator 204.

In one embodiment, the logging framework 220 generates the trace records to also include a use case identifier (UCID) that identifies the use case and an instance of the use case. In such embodiments, the trace records are correlated according to the UCID and the instance of the use case.

In one embodiment of the present disclosure, the obtained vulnerability information comprises a Common Vulnerabilities and Exposures (CVE) list comprising one or more entries. Each entry on the CVE list comprises a VID identifying a publicly known cybersecurity vulnerability for the one or more services currently deployed in the communications network.

In one embodiment, each entry on the CVE list further comprises the vulnerability score for a respective service currently deployed in a communications network.

In one embodiment of the present disclosure, the network node that implements the present aspects is a logging framework configuration node in the management system 200.

In one embodiment, the vulnerability information is received from a vulnerability entity associated with the management system 200. Additionally, in one embodiment, the list of one or more SCIDs is received from a configuration management entity 208 associated with the management system 200.

In one embodiment, one or both of the vulnerability entity and the configuration management entity are implemented by the logging framework configuration node.

In one embodiment, configuring the logging framework 220 configures one or more logging agent functions 222 of the logging framework 220 to generate the trace records to include the VID and the vulnerability score of the service.

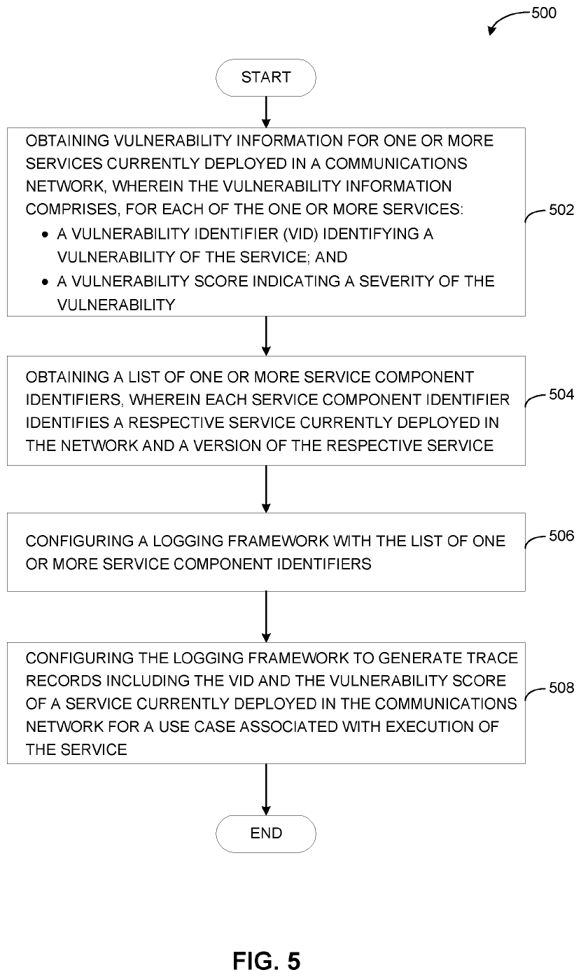

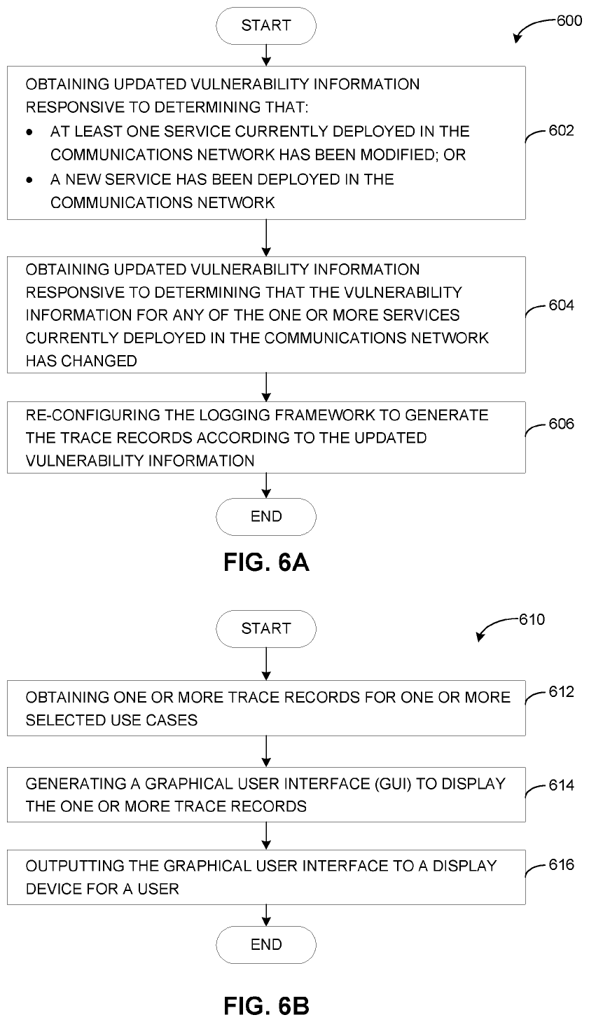

FIG. 6A is a flow diagram illustrating a method 600 for re-configuring the logging framework 220 to identify and log newly-discovered or changed vulnerabilities of the network services 230 according to one embodiment of the present disclosure. As seen in method 600, a network node obtains updated vulnerability information responsive to determining that at least one service currently deployed in the communications network has been modified, or that a new service has been deployed in the communications network (box 602). Additionally or alternatively, the network node may obtain updated vulnerability information responsive to determining that the vulnerability information for any of the one or more services 230 currently deployed in the network has changed (box 604). Regardless of how the updated vulnerability information has changed, however, the network node implementing method 600 re-configures logging framework 220 to generate the trace records according to the updated vulnerability information (box 606).

As previously described, the generated trace records are stored in a log DB 240 for subsequent analysis. FIG. 6B is a flow diagram illustrating a method 610 for analyzing the vulnerabilities identified in the stored log traces and for generating a graphical user interface (GUI) to graphically indicate those vulnerabilities to a user according to one embodiment of the present disclosure. Particularly, a network node implementing the management system 200 of the present disclosure obtains one or more trace records for one or more selected use cases and/or use case instances (box 612). For example, the selected trace records may be retrieved from the log DB 240 based on constraint information input into the GUI by a user. Then, based on the selected trace records, the management system 200 generates the GUI (box 614) and outputs the generated GUI to a display device for a user (box 616).

By way of example only, the management system 200 may generate the GUI to comprise one or more graphical indicators (e.g., graphs, etc.) that illustrate the particular vulnerabilities (i.e., the VIDs) and associated vulnerability scores that affect, or may potentially affect, a given use case. Additionally, the GUI may be generated to comprise one or more control objects that enable the user to select and apply one or more filters. Such filtering allows the user to focus on an analysis of the vulnerabilities associated with a particular service 230, a particular use case of that service 230, and/or a particular instance of a particular use case of the service 230. Once displayed, the graphical nature of the information enables the user to quickly identify the vulnerabilities of concern, and to subsequently implement a corrective action to address the vulnerabilities. Such corrective actions (e.g., remove a service from deployment, inactivate a service, block or restrict access to a service, and the like) may be automatically identified by the network node and graphically presented to the user via the GUI. In one embodiment, the user could then select an appropriate corrective action and initialize a procedure for implementing the corrective action.

Additionally, in at least one embodiment, the GUI generates one or more control objects based on information in the one or more trace records. In these cases, the one or more control objects may visually represent an extent to which the vulnerabilities affect a workload of the one or more services currently deployed in the communications network, as well as one or more locations in the network where the one or more services are affected by the vulnerabilities.

An apparatus can perform any of the methods herein described by implementing any functional means, modules, units, or circuitry. In one embodiment, for example, the apparatuses comprise respective circuits or circuitry configured to perform the steps shown in the method figures. The circuits or circuitry in this regard may comprise circuits dedicated to performing certain functional processing and/or one or more microprocessors in conjunction with memory. For instance, the circuitry may include one or more microprocessor or microcontrollers, as well as other digital hardware, which may include Digital Signal Processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory may include program instructions for executing one or more telecommunications and/or data communications protocols as well as instructions for carrying out one or more of the techniques described herein, in several embodiments. In embodiments that employ memory, the memory stores program code that, when executed by the one or more processors, carries out the techniques described herein.

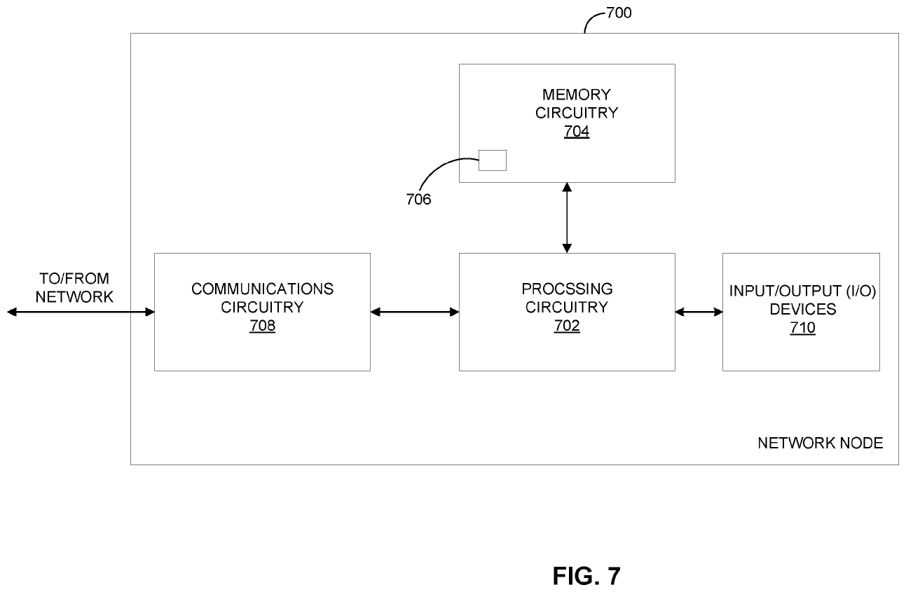

FIG. 7 is a schematic diagram illustrating some exemplary components of a network node 700 configured to implement aspects of the present disclosure. As stated above, network node 700 may be a logging framework configuration node in one embodiment.

As seen in FIG. 7, network node 700 comprises processing circuitry 702, memory circuitry 704, communications circuitry 708, and one or more input/output devices 710. The processing circuitry 702 controls the overall operation of the network node 700 and implements the methods as herein described. The processing circuitry 702 may comprise one or more microprocessors, hardware, firmware, or a combination thereof, and according to the present disclosure, is configured to perform one or more of the methods shown in FIGS. 3A-3B, 5, and 6A-6B.

More particularly, in one or more embodiments, the processing circuitry 702 is configured to obtain vulnerability information for one or more services 230 currently deployed in a communications network. For each service, the vulnerability information comprises a VID that identifies a vulnerability of the service, and a vulnerability score that indicates the severity of the vulnerability. Additionally, the processing circuitry 702 is configured to configure the logging framework 220 to generate trace records. Specifically, the processing circuitry 702 configures the logging framework 220 to generate the trace records for a service on a use case basis (i.e., for each use case of the service), and to include the UCID identifying the particular use case and use case instance, the VID identifying the particular vulnerability, and the vulnerability score associated with the VID.

Memory 704 comprises both volatile and non-volatile memory for storing computer program code and data needed by the processing circuit 702 for operation. Memory 704 may comprise any tangible, non-transitory computer-readable storage medium for storing data including electronic, magnetic, optical, electromagnetic, or semiconductor data storage. Memory 704 stores a computer program such as computer program 706 comprising executable instructions that configure the processing circuitry 702 to implement the methods according to any of FIGS. 3A-3B, 5, and 6A-6B, as described herein. Computer program 706 in this regard may comprise one or more code modules corresponding to the functions described above.

In general, computer program instructions and configuration information are stored in a non-volatile memory, such as a ROM, erasable programmable read only memory (EPROM) or flash memory. Temporary data generated during operation may be stored in a volatile memory, such as a random access memory (RAM). In some embodiments, the computer program such as computer program as herein described may be stored in a removable memory, such as a portable compact disc, portable digital video disc, or other removable media. The computer program may also be embodied in a carrier such as an electronic signal, optical signal, radio signal, or computer readable storage medium.

The communication circuitry 708 comprises the hardware and software required for communication between the various network nodes communicatively connected to the network node 700. For example, in one embodiment, communication circuitry 708 comprises ETHERNET circuitry for communicating with the other network nodes (e.g., the vulnerability DB 210, the logging framework 220, and the log DB 240). In another embodiment, however, communication circuitry 708 comprises RF circuitry for communication between network nodes over a RF channel.

The Input/Output (I/O) devices 710 may comprise any device known in the art that permits a user to interact with network node 700. By way of example only, I/O devices 710 may include, but are not limited to, a keyboard, keypad, a mouse or other pointer device, speakers, microphones, and one or more display devices. In one embodiment, processing circuitry 702 is configured to generate a GUI that includes information gleaned from one or more selected trace records obtained from the log DB 240, and output that GUI to a display device for a user as previously described. In this regard, the display device may be any display device known in the art that is capable of displaying graphics to a user.

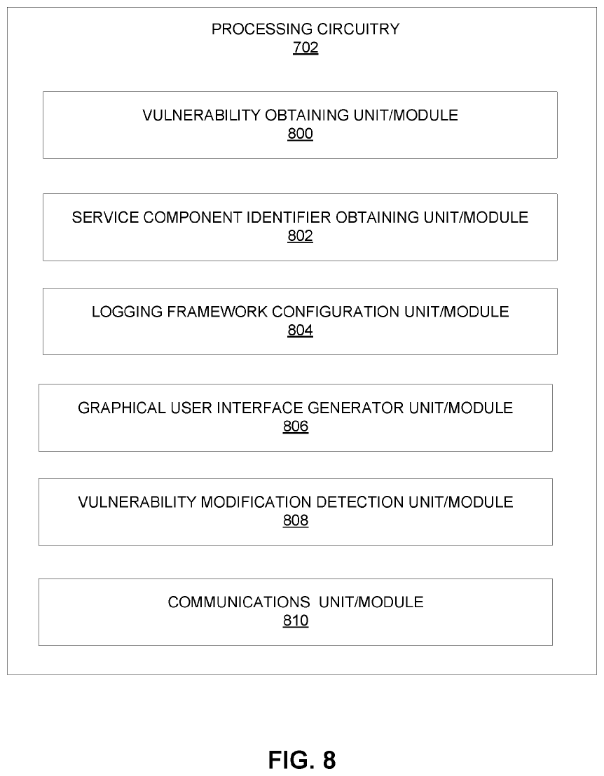

FIG. 8 is a functional block diagram illustrating an example computer program, such as computer program 706, for example, that, when executed by the processing circuitry 702 of network node 700, configures the network node 700 to implement aspects of the present disclosure. As seen in FIG. 8, the computer program 706 executed by processing circuitry 702 comprises a plurality of units/modules including a vulnerability obtaining unit/module 800, a service component identifier obtaining unit/module 802, a logging framework configuration unit/module 804, a graphical user interface generator unit/module 806, a vulnerability modification detection unit/module 808, and a communications unit/module 810. Each of the unit/modules may be implemented, for example, as hardware and/or software code implemented by processing circuitry 702.

The vulnerability obtaining unit/module 800 comprises instructions that, when executed by processing circuitry 702, configures network node 700 to obtain vulnerability information for one or more services 230 from a vulnerability DB 210, as previously described.

The service component identifier obtaining unit/module 802 comprises instructions that, when executed by processing circuitry 702, configures network node 700 to obtain the service component identifiers (SCIDs) for one or more services 230 currently deployed in the network from CM 208, as previously described.

The logging framework configuration unit/module 804 comprises instructions that, when executed by processing circuitry 702, configures network node 700 to receive the SCIDs and vulnerability information from the vulnerability manager 202, and to generate one or more configuration files based on that received information to send to the logging framework 220, as previously described.

The graphical user interface generator unit/module 806 comprises instructions that, when executed by processing circuitry 702, configures network node 700 to generate a GUI to display information gleaned from trace records retrieved from the log DB 240 and to output that GUI to a display device for display to a user, as previously described.

The vulnerability modification detection unit/module 808 comprises instructions that, when executed by processing circuitry 702, configures network node 700 to detect when the known vulnerabilities of a given service 230 have changed, and to indicate that change to the vulnerability obtaining unit/module 800 so it can retrieve the new or updated vulnerability information, as previously described.

The communications unit/module 810 comprises instructions that, when executed by processing circuitry 702, configures network node 700 to establish and maintain communication links with one or more other nodes connected to the network (e.g., vulnerability DB 210, logging framework 220, and log DB 240) and to communicate data with those nodes, as previously described.

Accordingly, the present embodiments provide a technology that allows network operators and/or security administrators associated with cloud native execution environments to be cognizant of vulnerability-affected use case occurrences related to services that are actively deployed and running in live environments, and further, to understand the impact of those vulnerabilities on the services and systems. Moreover, the present embodiments identify the vulnerabilities on a use case basis, and therefore, configure the generation of trace records to include the UCIDs identifying the particular use case and instance of the use case, the VIDs and corresponding vulnerability score (i.e., the severity of the vulnerability), and the SCID of the particular software component producing the trace records. Additionally, the network node implementing these functions is also configured to generate a GUI to display the vulnerability-affected use cases, with filtering capabilities on vulnerability identifiers and/or severity, store the generated trace records in a storage medium (e.g., a database), and automatically and autonomously adapt in real-time to any changes in vulnerabilities associated with the services 230, as well as to any changes in the services 230 and/or their versions deployed in clusters in the network.

The present invention may, of course, be carried out in other ways than those specifically set forth herein without departing from essential characteristics of the invention. The present embodiments are to be considered in all respects as illustrative and not restrictive, and all changes coming within the meaning and equivalency range of the appended claims are intended to be embraced therein.

1-25. (canceled)

26. A method for configuring logging in telecommunication networks executing one or more services in a distributed workflow, the method implemented by a network node in a management system and comprising:
obtaining vulnerability information for one or more services currently deployed in a communications network, wherein the vulnerability information comprises, for each of the one or more services:
a vulnerability identifier (VID) identifying a vulnerability of the service; and
a vulnerability score indicating a severity of the vulnerability; and
configuring a logging framework to generate trace records including the VID and the vulnerability score of a service currently deployed in the communications network for a use case associated with execution of the service.

27. The method according to claim 26, wherein the logging framework is configured to generate at least one trace record including a plurality of VIDs and a plurality of corresponding vulnerability scores, and wherein each VID in the at least one trace record identifies a different vulnerability of the service.

28. The method according to claim 26, further comprising:
obtaining a list of one or more service component identifiers, wherein each service component identifier identifies a respective service currently deployed in the network and a version of the respective service; and
configuring the logging framework with the list of one or more service component identifiers.

29. The method according to claim 28, wherein the logging framework is configured to generate the trace records when a service component identifier of the service associated with the use case matches a service component identifier on the list of one or more service component identifiers.

30. The method according to claim 26, wherein the logging framework generates the trace records to include a use case identifier (UCID) identifying the use case and an instance of the use case.

31. The method according to claim 30, wherein the trace records are correlated according to the UCID and the instance of the use case.

32. The method according to claim 26, wherein the vulnerability information comprises a Common Vulnerabilities and Exposures (CVE) list identifying one or more publicly known cybersecurity vulnerabilities for the one or more services currently deployed in the communications network.

33. The method according to claim 32, wherein each entry on the CVE list comprises the VID and the vulnerability score for a respective service currently deployed in a communications network.

34. The method according to claim 26, further comprising:
obtaining updated vulnerability information responsive to determining that:
at least one service currently deployed in the communications network has been modified; or
a new service has been deployed in the communications network; and
re-configuring the logging framework to generate the trace records for the use case according to the updated vulnerability information.

35. The method according to claim 26, further comprising:
obtaining updated vulnerability information responsive to determining that the vulnerability information for any of the one or more services currently deployed in the communications network has changed; and
re-configuring the logging framework to generate the trace records according to the updated vulnerability information.

36. The method according to claim 26, wherein configuring the logging framework configures one or more logging agent functions of the logging framework to generate the trace records including the VID and the vulnerability score of the service.

37. The method according to claim 26, further comprising:
obtaining one or more trace records for one or more selected use cases;
generating a graphical user interface (GUI) to display the one or more trace records; and
outputting the graphical user interface to a display device for a user.

38. The method according to claim 37, wherein the GUI is generated to include one or more control objects based on information in the one or more trace records, wherein the one or more control objects visually represent:
an extent to which the vulnerabilities affect a workload of the one or more services currently deployed in the communications network; and
one or more locations in the communications network where the one or more services are affected by the vulnerabilities.

39. The method according to claim 26, wherein the network node is a logging framework configuration node.

40. The method according to claim 39, wherein the vulnerability information is received from a vulnerability entity associated with the management system.

41. The method according to claim 40, wherein the list of one or more service component identifiers is received from a configuration management entity associated with the management system.

42. The method according to claim 41, wherein one or both of the vulnerability entity and the configuration management entity are implemented by the logging framework configuration node.

43. A network node in a management system for configuring logging in telecommunication networks executing one or more services in a distributed workflow, the network node configured to:
obtain vulnerability information for one or more services currently deployed in a communications network, wherein the vulnerability information comprises, for each of the one or more services:
a vulnerability identifier (VID) identifying a vulnerability of the service; and
a vulnerability score indicating a severity of the vulnerability; and
configure a logging framework to generate trace records including the VID and the vulnerability score of a service currently deployed in the communications network for a use case associated with execution of the service.

44. A network node in a management system for configuring logging in telecommunication networks executing one or more services in a distributed workflow, the network node comprising:
processing circuitry; and
memory circuitry comprising instructions that, when executed by the processing circuitry, causes the network node to:
obtain vulnerability information for one or more services currently deployed in a communications network, wherein the vulnerability information comprises, for each of the one or more services:
a vulnerability identifier (VID) identifying a vulnerability of the service; and
a vulnerability score indicating a severity of the vulnerability; and
configure a logging framework to generate trace records including the VID and the vulnerability score of a service currently deployed in the communications network for a use case associated with execution of the service.

45. A non-transitory computer readable medium comprising instructions stored thereon for managing telecommunication networks that, when executed by processing circuitry of a network node, configures the network node to:
obtain vulnerability information for one or more services currently deployed in a communications network, wherein the vulnerability information comprises, for each of the one or more services:
a vulnerability identifier (VID) identifying a vulnerability of the service; and
a vulnerability score indicating a severity of the vulnerability; and
configure a logging framework to generate trace records including the VID and the vulnerability score of a service currently deployed in the communications network for a use case associated with execution of the service.
